(19) United States
(12) Patent Application Publication
(10) Pub. No.: US 2004/0012594 A1
(43) Pub. Date: Jan. 22, 2004

(54) Generating animation data

(76) Inventors: Andre Gauthier, St-Jacques Le Mineur (CA); Robert Lanciault, Sante-Julie (CA)

Correspondence Address: HARNESS, DICKEY & PIERCE, P.L.C., P.O. BOX 828, BLOOMFIELD HILLS, MI, 48303, US

(21) Appl. No.: 10/314,024

(22) Filed: Dec. 6, 2002

(30) Foreign Application Priority Data
Jul. 19, 2002 (GB) GB 0216819.3

(51) Int. Cl. G09G 5/00

(52) U.S. Cl. 345/473

(57) ABSTRACT

An apparatus and method are provided for generating animation data, including storage means comprising at least one character defined as a hierarchy of parent and children nodes and animation data defined as the position in three-dimensions of said nodes over a period of time, memory means comprising animation instructions, wherein said processing means are configured by said animation instructions to perform the steps of animating said character with first animation data; selecting nodes within said first animation data when receiving user input specifying second animation data in real-time; respectively matching said nodes with corresponding nodes within said second animation data; respectively interpolating between said nodes and said matching nodes; and animating said character with second animation data having blended a portion of said first animation data with said second animation data.

### BACKGROUND OF THE INVENTION

1. Field of the Invention

The present invention relates to the real time generating of animation data for animating a character, wherein said animation data comprises a plurality of motion sequences which require blending.

2. Description of the Related Prior Art

In the field of computer aided character animation, character motion is traditionally achieved by means of modifying the three-dimensional position of the various components of a character, for instance the body parts of a human character, over a succession of frames, known as an animation sequence, and preferably with reference to a pre-production script which lists the character's required motions in relation to a narrative.

Numerous methods are known with which to generate motion or action data for animating a character. Any such character is traditionally defined as a bio-mechanical model comprising a hierarchy of parent and children nodes, wherein the inter-relations between the node-connected various “bones” of said bio-mechanical model define said hierarchy, e.g. a foot is attached to an ankle is attached to a shin bone is attached to a knee is attached to a thigh is attached to a hip, such that the hip is the parent node and all other inferior bones are its children. Motion or action data with which to animate such a model traditionally comprises generic motion clips, such as a walk animation or a run animation, wherein each of said clips defines the position of the aforementioned parent and children nodes in two- or three-dimensional space in each frame of a sequence of frames representing one such motion, such as a walk motion or a run motion.

Generic motion clips are usually grouped into libraries in order to be used and re-used over time, because the positional data contain therein is traditionally derived from motion capture. Motion capture is well known to those skilled in the art and involves the optical capture of the relative position in three-dimensional space of the aforementioned nodes as contrast markers worn by an actor performing motions as outlined above. Motion capture is an expensive and complex process, therefore the re-usability of generic motion clips derived therefrom is advantageous.

The cost-effectiveness of using libraries of generic motion clips may however be outweighed by placing severe restrictions on the creative input of animators and, as ever-increasing realism is demanded from computer-aided character animation, problems arise when a plurality of such generic motion clips are used sequentially to animate a character with a range of back to back motions.

Indeed, a motion clip is traditionally played to its logical end until a second motion clip selected in real time can be played, in known real time character animation applications. Although animator input selecting said second motion clip may be provided in real time, e.g. whilst the first clip is still being processed to animate a character and rendered, the animation of the character with said second clip does not begin until after the last frame of said first clip has been processed and rendered. Visible artefacts may result from the above prior art method, especially when the respective positions of the character nodes change dramatically between the last frame of the first clip and the first frame of the second clip relative to one another.

A solution is known to remedy the above problem which consists of manually blending such sequential motion clips. In most animation systems, for instance for generating a sequence of motions for animating a character in a cinematographic production, a high degree of character motion accuracy is required, whereby blending motion clips involves the expensive and time-consuming adjustment of visual cues by an animator between frames of each motion clip, wherein said clues are usually the nodes represented within a three-dimensional space within which the sequence of motions takes place, known as an animation space.

The problem inherent to the above method is that it does not take place in real-time, whereby an animator must manually adjust the respective positions of the nodes between the last valid frame of a first motion clip and the first valid frame of a second motion clip to take into account factors such as extent of the translation, rotation, scaling and velocity of said nodes. Only then are animation frames generated in-between said last valid frame and said first valid frame to render a smooth clip blend, a process known as inbetweening.

Moreover, the above adjustments are required not only for most of the parent nodes of a character but also for the node(s) closest to the relative floor of the animation space. This last positional problem may be resumed as the fact that uniform floor designation in each motion clip does not correspond to uniform animation path elevation in a sequence of such clips. That is, although each motion is preferably defined in relation to a floor level in a motion clip, the difference between the positional data of nodes in the last valid frame of a first clip and the positional data of nodes in the first valid frame of a next clip may artificially lower or raise the floor level of said second clip relative to the floor level in said first clip: a character which say walks normally according to the first clip would be lowered by say 10 inches when the next clip is processed and give the impression that its feet find support 10 inches below the floor level of the fist clip.

A need therefore exists for a method of generating animation data for animating a character, wherein the blending of a first motion clip into a second motion clip is inexpensively performed in real-time in reply to animator input, whilst maintaining a high degree of positional accuracy to avoid generating artefacts in the character's motions.

### BRIEF SUMMARY OF THE INVENTION

According to a first aspect of the present invention, there is provided an apparatus for generating animation data, including storage means comprising at least one character defined as a hierarchy of parent and children nodes and animation data defined as the position in three-dimensions of said nodes over a period of time, memory means comprising animation instructions, wherein said processing means are configured by said animation instructions to perform the steps of animating said character with first animation data; selecting nodes within said first animation data when receiving user input specifying second animation data in real-time; matching said nodes with corresponding nodes within said second animation data; interpolating between said nodes and said matching nodes; and animating said character with second animation data having blended a portion of said first animation data with said second animation data in real time.

According to another aspect of the present invention, there is provided a method for generating animation data, including storage means comprising at least one character defined as a hierarchy of parent and children nodes and animation data defined as the position in three-dimensions of said nodes over a period of time, memory means comprising animation instructions, wherein said processing means are configured by said animation instructions to perform the steps of animating said character with first animation data; selecting nodes within said first animation data when receiving user input specifying second animation data in real-time; matching said nodes with corresponding nodes within said second animation data; interpolating between said nodes and said matching nodes; and animating said character with second animation data having blended a portion of said first animation data with said second animation data in real time.

In an alternative embodiment of the present invention, said processing means are further configured by said animation instructions to perform the step of configuring input data to be generated in real time by user-operable input devices. Said matching step preferably includes comparing node names or node references or portions thereof.

In the alternative embodiment still, said storage means preferably comprises a plurality of characters, whereby said processing means animate a plurality of characters with first and second animation data. Said nodes preferably include at least one root node and one pivot point.

In the preferred embodiment of the present invention, said interpolation is linear. In an alternative embodiment of the present invention, said interpolation is cubic. Preferably, the velocity of said interpolation is a function of the velocity of said nodes in said first animation data, and said velocity is preferably but not necessarily constant.

In the preferred embodiment of the present invention, said said animation is keyframe-based. In an alternative embodiment of the present invention, however, said interpolation is forward kinematics-based or inverse kinematics-based.

### BRIEF DESCRIPTION OF THE SEVERAL VIEWS OF THE DRAWINGS

FIG. 1 shows a computer animation system for animating a character according to the present invention;

FIG. 2 shows illustrates the physical structure of the computer system identified in FIG. 1;

FIG. 3 details the processing steps performed by the computer animation system shown in FIGS. 1 and 2 according to the present invention;

FIG. 4 details the memory map of instructions stored within the computer animation system shown in FIG. 2, including a target sequence, a library of animation clips and a library of model hierarchies;

FIG. 5 details the processing steps according to which input data relating to the target sequence shown in FIG. 4 is configured;

FIG. 6 illustrates the association of a generic humanoid topology with a hierarchy of nodes;

FIG. 7 illustrates a library of generic motion clips with which to animate the generic humanoid shown in FIG. 6;

FIG. 8 illustrates the association of the humanoid topology shown in FIG. 6 with the generic motion clips shown in FIG. 7 into the target scene shown in FIG. 4, which defines a timeline;

FIG. 9 provides a representation of the graphical user inter-face of the animation application shown in FIG. 4, including a representation of the target scene shown in FIG. 8;

FIG. 10 summarises operations performed according to the known prior art to blend a first motion clip into a second motion clip in the target scene shown in FIGS. 8 and 9;

FIG. 11 illustrates a common problem with animation blending and a solution said problem according to the known prior art shown in FIG. 10;

FIG. 12 details the processing steps of the blending operation shown in FIG. 3 according to the present invention;

FIG. 13 details the processing step of matching current and target nodes in the target animation sequence shown in FIG. 12;

FIG. 14 graphically depicts the matching operations shown in FIG. 13;

FIG. 15 details the processing steps of the interpolation between the current root node and the target root shown in FIG. 12;

FIG. 16 graphically depicts the interpolation shown in FIG. 15 within the animation space shown in FIG. 9;

FIG. 17 details the processing steps of the interpolation between the current pivot point and the target pivot point shown in FIGS. 12 and 16;

FIG. 18 graphically depicts a problem arising out of the constant velocity approach applied to derive blending velocity shown in FIG. 12 when using cubic curve interpolation;

FIG. 19 details the processing steps to derive blending velocity, which solve the problem described in FIG. 18;

FIG. 20 graphically depicts a relationship between the time parameter and the distance travelled to overcome the problem shown in FIG. 18 according to the processing steps described in FIG. 19.

### WRITTEN DESCRIPTION OF THE BEST MODE FOR CARRYING OUT THE INVENTION

The invention will now be described by way of example only with reference to the previously identified drawings.

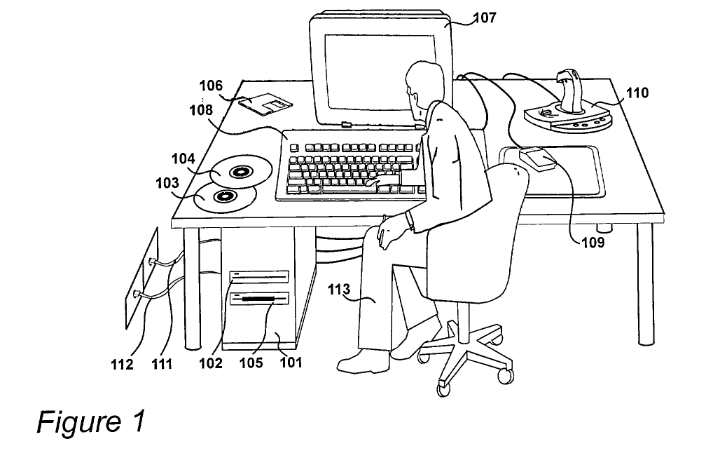

FIG. 1

A computer animation system is shown in FIG. 1 and includes a programmable computer 101 having a drive 102 for receiving CD-ROMs 103 and writing to CD-ROMs 104 and a drive 105 for receiving high-capacity magnetic disks, such as zip disks 106. According to the invention, computer 101 may receive program instructions via an appropriate CD-ROM 103 or action data may be written to a re-writeable CD-ROM 104, and motion clips may be received from or action data may be written to a zip disk 106 by means of drive 105. Output data is displayed on a visual display unit 107 and manual input is received via a keyboard 108, a mouse 109 and a joystick 110.

Data may also be transmitted and received over a local area network 111 or the Internet by means of modem connection 112 by the computer animation system operator, i.e. animator 113. In addition to writing animation data in the form of action data to a disk 106 or CD-RAM 104, completed rendered animation frames may be written to said CD-RAM 104 such that animation sequence data, in the form of video material, may be transferred to a compositing station or similar.

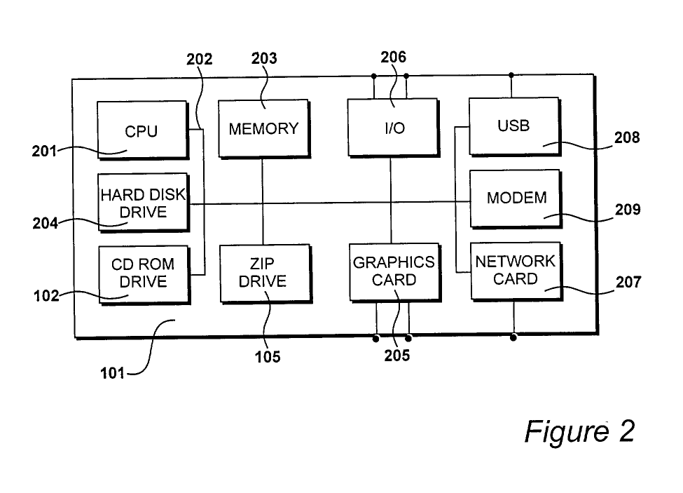

FIG. 2

The components of computer system 101 are detailed in FIG. 2. The system includes a Pentium 4 central processing unit (CPU) 201 operating under instructions received from random access memory 203 via a system bus 202. Memory 203 comprises five hundred and twelve megabytes of randomly accessible memory and stores executable programs which, along with data, are received via said bus 202 from a hard disk drive 204. A graphics card 205 and input/output interface 206, a network card 207, a zip drive 105, a CD-ROM drive 102, a Universal Serial Bus (USB) interface 208 and a modem 209 are also connected to bus 202. Graphics card 205 supplies graphical data to visual display unit 107 and the I/O device 206 or USB 208 receives input commands from keyboard 108, mouse 109 and joystick 110. Zip drive 105 is primarily provided for the transfer of data, such as motion clip data, and CD-ROM drive 102 is provided for the loading of new executable instructions to the hard disk drive 204 and the saving of animation sequence data in video- or data form.

The hardware components detailed in FIG. 2 are for illustrative purposes only and it will be readily apparent to those skilled in the art that said components may vary to a fairly large extent, in individual specification such as the CPU type or the amount of RAM and/or the architecture thereof according to which manufacturer, such as Apple Inc., Sillicon Graphics Inc. or International Business Machines, built computer system 101.

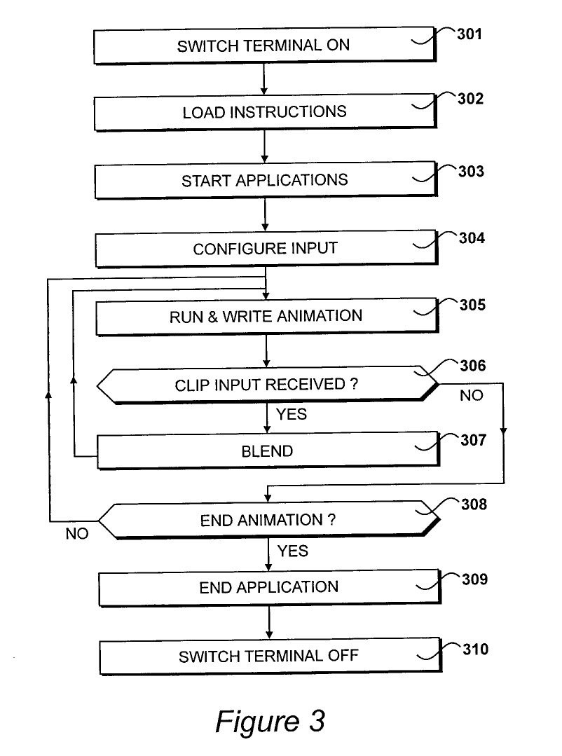

FIG. 3

At step 301, the computer system 101 is switched on, whereby all instructions and data sets necessary to generate animation data are loaded at step 302. At step 303, the set of instructions specifically instructing central processing unit 201 to generate and process animation data is started. Said set of instructions preferably provides for the configuration of input means, such as keyboard 108, mouse 109 or joystick 110 and further, for the configuration of input data generated by said input means, for instance which motion clips are triggered by which real-time action formed upon said input means, at step 304.

At step 305, an animation sequence is generated by computer aided animation system 101 and, in a preferred embodiment of the present invention, the various data sets defining said animation sequence are written either to hard disk drive 204, a re-writable CD ROM 104 by means of CD ROM drive 102 or a zip disk 106 by means of zip drive 105. According to the preferred embodiment of the present invention, the animation sequence is generated and written at step 305 in real-time, whereby a question is repeatedly asked at step 306 for each cycle of the processing of said animation instruction set, which asks whether input data has been received to the effect that a next motion clip has been selected.

If the question of step 306 is answered positively, then the animation instructions according to the invention blend said next selected motion clip with the motion clip currently being processed at step 307, whereby control is returned to step 305 such that various data sets of the animation sequence can be processed and written in real-time. Alternatively, if the question of step 306 is answered negatively, a second question is asked at step 308 as to whether the animation sequence being generated and written at step 305 is now finished. If the question of 308 is answered negatively, for instance because the animator operating the computer aided animation system wishes to animate a character after a period of time from the end of the motion clip currently being processed, effectively animating said character with a motion pause, control is again returned to step 305. Alternatively, if the question of step 308 is answered positively, the animation sequence is effectively finished and the animation instructions set started at step 303 may now be ended at step 309. The computer aided animation system 101 may eventually be switched off at step 310.

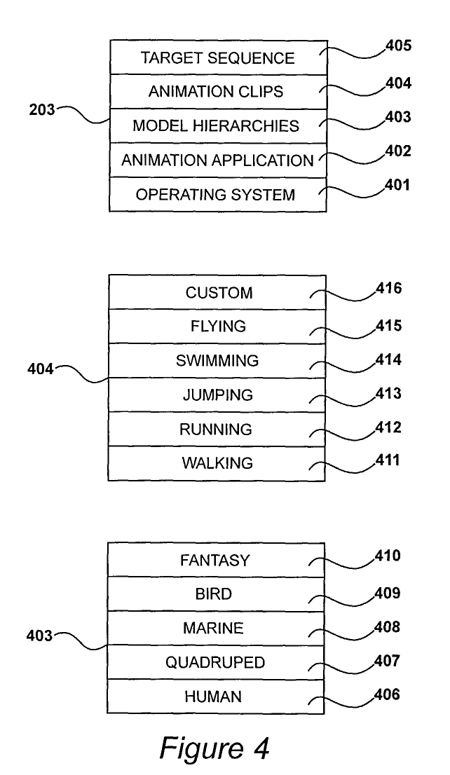

FIG. 4

A summary of the contents of the main memory 203 of the computer system 101 is shown in FIG. 4, as subsequently to the starting of instructions processing at step 303 according to the invention.

Main memory 203 includes an operating system 401, which is preferably Microsoft® Windows® 2000, as said operating system is considered by those skilled in the art to be particularly stable when using computationally intensive applications, such as an animation application. It will be easily understood by those skilled in the art that the present invention may equally use alternative operating systems, such as Apple MacOSX® or LINUX®, again depending upon the architecture of computer system 101. Operating system 401 preferably includes optional utilities such as an Internet Browser and configuration instructions for joystick 110.

In addition to animation instructions 402, which represent the executable portion of the animation instructions according to the present invention, main memory 203 includes data sets from which and with which animation instructions 402 animate a character.

Said data sets comprise a library 403 of model hierarchies, a library 404 of animation clips and at least one target animation sequence 405, which will respectively further detailed below.

Model hierarchies 403 essentially include a variety of hierarchies of nodes, each of which defines a particular bio-mechanical model. In the example, such model hierarchies include a humanoid model 406 to be invoked in order to animate bipedal characters with a mostly humanoid appearance, a quadruped model 407 to be used in order to animate four-legged characters, a marine model 408 to be used for animating fish-like characters, a bird model 409 to be used for animating characters configured with wings and a fantasy model 410 as for instance a non-natural combination of the above models or a totally new hierarchy of nodes.

Motion clips 404 comprise a plurality of generic motion clips, each of which defines a particular nodal configuration of the aforementioned bio-mechanical models over a period of frames representing a particular motion. Accordingly, motion clips 404 may comprise a walking motion clip 411, a running motion clip 412, a jumping motion clip 413, a swimming motion clip 414, a flying motion clip 415 or a custom motion clip 416, such as an edited version of a generic motion clip, for instance a walking motion afflicted with a hobble.

The above generic motion clips are presented as an example only and it will be obvious to one skilled in the art that such clips may potentially number hundreds or even thousands. Similarly, the present description will focus upon a bipedal humanoid model, but it will be obvious to one skilled in the art that different versions of a walking motion clip, such as walking motion clip 411, would have to be provided according to whether a bipedal humanoid model or a quadruped model should be animated with said walk.

The target sequence 405 will be further detailed below, but may simply be understood as the synthesis of one or a plurality of model hierarchies 406 to 410, each animated with one or a plurality of motion clips 411 to 416, within an animation space over a period of time.

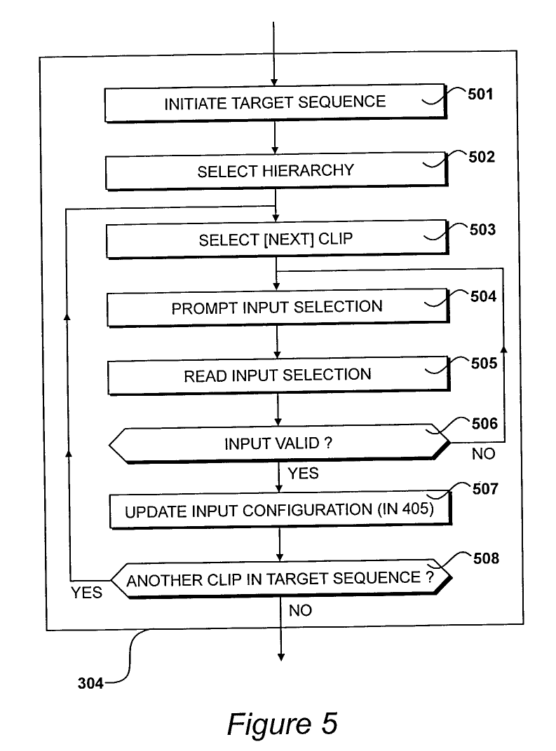

FIG. 5

The operational steps according to which the instructions and data sets shown in FIG. 4 are configured for input according to process step 304 shown in FIG. 3 are further detailed in FIG. 5.

At step 501, the target animation sequence 405 is initiated either by reading a pre-existing such target sequence from hard disk drive 204 or any other removable media as described above or as a new animation sequence. At step 502, at least one nodal hierarchy is selected from model hierarchies 403 as the nodal hierarchy to be animated within the target animation sequence initiated at step 501.

At step 503, a motion clip is selected from the library 404 of motion clips 411 to 416, whereby animation instructions 402 prompt animator 113 at step 504 to select a preferred input configuration for the real-time selecting of said clip to blend said selected clip in real-time at step 307. The animator's input selection is subsequently read at step 505, whereby a question at step 506 as to whether the input configuration selected according to step 505 constitutes valid input data. For instance, animator 113 may have selected a function key of key board 108 according to step 505, the functionality of which is defined by animation instructions 402 as exclusively reserved for terminating the processing of said animation instructions according to step 309 and such selected input would clearly be invalid.

Thus, if question 506 is answered negatively, animation instructions 402 return control to step 504, whereby animator 113 is again prompted for a valid input selection. Alternatively, if the question of step 506 is answered positively, the input data configuration specific to the target animation sequence initiated at step 501 is updated with the model hierarchy selected at step 502 and the motion clip selected at step 503.

According to the preferred embodiment of the present invention, at least two motion clips should be selected at step 503, for instance a walking motion clip 411 and a running motion clip 412, such that animation instructions 402 may blend one motion into the other and reciprocally according to a script detailing the sequence of motions with which to animate the character selected at step 502 and the timing thereof. Consequently, a question is asked at step 508 as to whether another clip should be selected for the target animation sequence selected at step 501. If the question at step 508 is answered positively, control is returned to step 503, whereby another motion clip is selected within library 404 and the specific input configuration thereof equally selected and updated according to the processing steps detailed thereabove.

In an alternative embodiment of the present invention, a plurality of a model hierarchies 403 are selected at step 502 to be animated within the target animation sequence selected at step 501, either simultaneously with a same range and sequence of motion clips or individually with different motion clips at any one time, whereby the motion clip selection and respective configuration according to steps 503 to 508 are defined for each of said selected model hierarchies.

The input configuration of step 304 is eventually achieved, whereby the animation sequence may now be processed and written according to the next step 305.

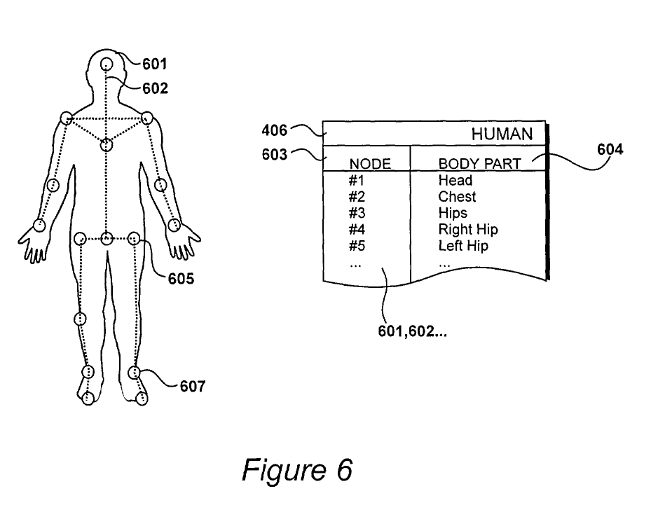

FIG. 6

A hierarchy of nodes 403, such as the “humanoid” hierarchy 406, is shown in FIG. 6.

As generic motion clips relate in most instances to captured performance data, most sets of nodes relate to a humanoid topology such as represented by generic actor 601, which is itself initially based on an actor performing said motions in the real world. Thus, whereas it would be perfectly acceptable for a character with a humanoid topology 406 to be animated with a “jump” motion clip 413, and to render said character as performing said jump over an imaginary distance of say one mile, it would however not be acceptable to animate the body parts defining said imaginary humanoid character with motion performance captured from a quadruped, as morphological differences invalidate the nodal configuration 406. Said motion performance captured from the body parts of a quadruped would be used to animate a quadruped hierarchy 407 instead.

This description of the present embodiment will focus upon the lower limb nodes of a bipedal, humanoid model, but it will be easily understood by those skilled in the art that the principles described herein are equally applicable to animate a potentially infinite variety of hierarchies of nodes, whether as a whole or a portion thereof.

As the purpose of said nodes is to reference the movement in two or three dimensions of body parts during a generic motion, said nodes are located at the joints between said body parts, or extremities, such that a bio-mechanical model 602 can be mathematically derived from said node hierarchy 406 in order to visualise the motion thereof with the least possible computational overhead allocated to character rendering, if any at all. Therefore, according to the invention, a character to be animated with a sequence of motion clips does not need to be fully or even partially rendered as a three-dimensional mathematical model comprising individual mathematically-modelled body parts constructed from polygons defining lines and curves and potentially over-laid with bitmapped polygonal textures, as motion clips can be selected in real-time to only animate the bio-mechanical model 602 in order to reduce the load of CPU 201.

Said bio-mechanical model 602 thus comprises a set 603 of nodes, classified as parent and children nodes according to the hierarchy 406 and possibly further incorporating intermediate and sibling nodes. Preferably, the hierarchy 406 associates all of the nodes 603 with a node name 604 suited to the bio-mechanical model 602 they collectively define. Thus, a “left leg” lower limb firstly comprises a “hips” parent node 605, also known as the root node of the entire limb. Said leg next includes an “knee” child node 606 and an “ankle” child node 607.

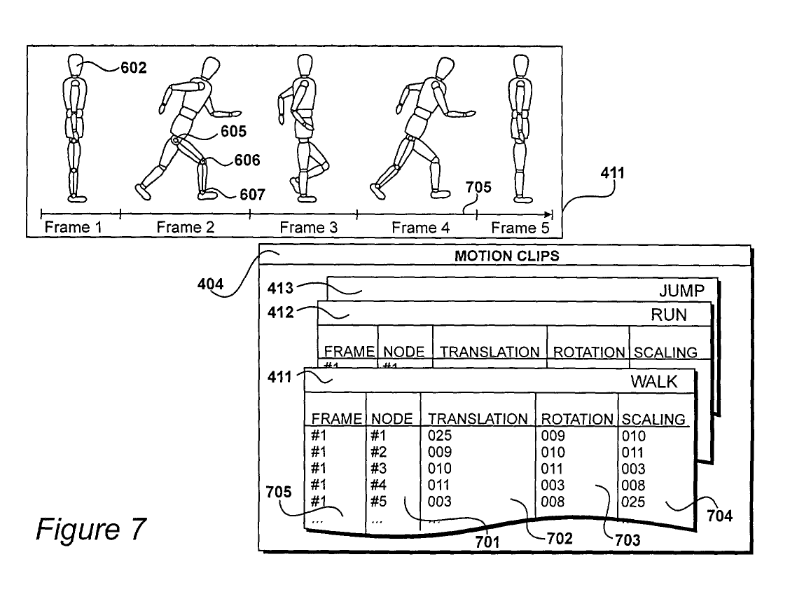

FIG. 7

The generic motions library 404 stores motion clips from previously captured performance data indexed under the descriptive name of the motion, ie “walk” 411, “run” 412, “jump” 413 etc., or motion clips as sets of keyframes not previously captured from performance data but also indexed under the descriptive name of the motion for clarity of reference.

For each indexation 411, 412 and 413 of said previously captured performance or sets of keyframes, its respective data comprises a comprehensive array of node references 701 uniquely defining the various body parts of a generic character as previously described, such that said references 701 may be matched to hierarchy 406. Said data also comprises the three-dimensional co-ordinates of said nodes 701, expressed in terms of translation 702, rotation 703 and scaling 704 in each frame within a succession of frames 705 at least equivalent to one cycle of the motion.

For instance, in the case of the “walk” motion clip 411, the data includes the translation 702, rotation 703 and scaling 704 coordinates of each of the nodes 603 defining the various body parts 604 of a generic character 601 in each frame, over a succession of frames 705 of say five frames, starting with the generic character's right foot moving forward from a ‘rest’ position to said right foot returning to a ‘rest’ position after the left foot respectively left and returned to a resting position, therefore defining a complete ‘walk’ motion 411.

Thus, upon selecting a generic motion clip within library 404 by means of animation instructions 402, a hierarchy of nodes 406 defining a character 601 is animated with a motion clip, as for each generic motion clip 411, 412, 413 etc. included in the generic motion clips library 404, the respective movements of each of the body parts 604 of a character can be correlated by way of the co-ordinates 702, 703, 704 of their respective nodes 603 over the succession of frames 705 defining the motion.

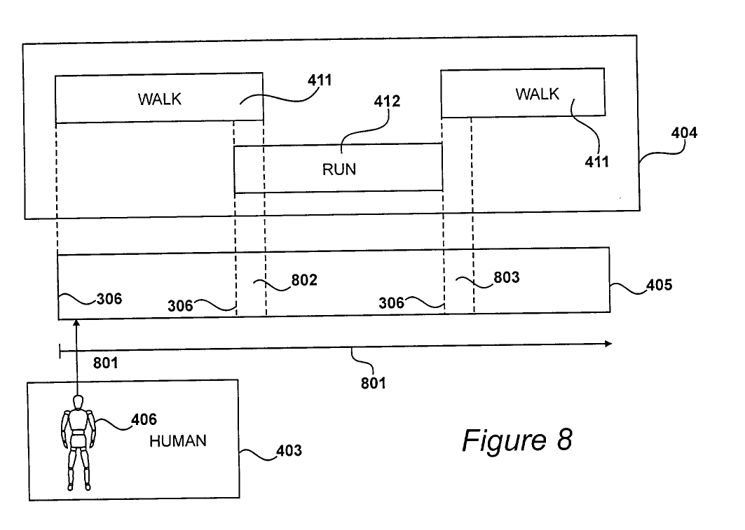

FIG. 8

The association of the model hierarchy described in FIG. 6 with the plurality of motion clips described in FIGS. 5 and 7 into the target sequence shown in FIGS. 4 and 5 is shown in FIG. 8.

The hierarchy of parent and children node 406 is selected among the model hierarchies 403 in order to animate a humanoid bipedal character 601 in a target animation sequence 405 primarily defined as a time-line 801 that may be expressed as a number of frames or a duration of time or a combination thereof to accommodate the various number of frames per unit of time inherent to the existing various movie and video display formats. For instance, a target animation sequence specified in terms of duration may not include the same amount of frames according to whether it will be used in a movie (with a frame display rate of twenty four frames per second), a video production (twenty nine point ninety seven frames per second for NTSC video or twenty five frames per second for PAL video) or a digital production(potentially limitless number of frames per second).

Motion clips 411 and 412 are selected within library 404 and also included in target animation sequence 405 as presently described, the respective input configuration of which at step 304 allows animation instructions 402 to process the data therein according to step 305 when they are triggered in real-time according to step 306.

In the example, the animation script requires the model to walk during a first period, then suddenly break into a run before again resuming to a walk. Consequently, first clip input is received according to step 306, whereby said model is animated with a walk motion 411 from an initial resting position, wherein no motion clip blending is required, with reference to the description of the walk motion clip in FIG. 7.

A first blending operation 802 is however generated from a second input 306 provided in real-time before the notional end of the first selected walk motion 411. Said blending operation 802 may initially be defined in terms of its duration, preferably as a number of frames and its duration shall not exceed the total number of frames remaining to be processed in said first walk motion clip 411 according to the present invention. In the example, the duration of the first blending operation 802 equals ten frames, whereby in accordance with the present invention, clip selection input 306 is received in real-time during the output of the first frame of said ten frames, wherein the notional character is walking and said character is actually running by the time said tenth frame is output.

In the example described herein, the transition between the first walk motion clip 411 and the second run motion clip 412 during blending operation 802 is linear, i.e. carried out at a constant speed but. In a preferred embodiment of the present invention, however, the duration of said transition is a function of the acceleration and velocity variables equipping the model being animated at the time said second motion clip input 306 is received, which will be further detailed below.

In the example still, a third motion clip which is a second selection of the first walk motion clip 411 is again received in real-time, but said input is received during the output of the last frame of the second run motion clip 412, thus generating a second blending operation 803.

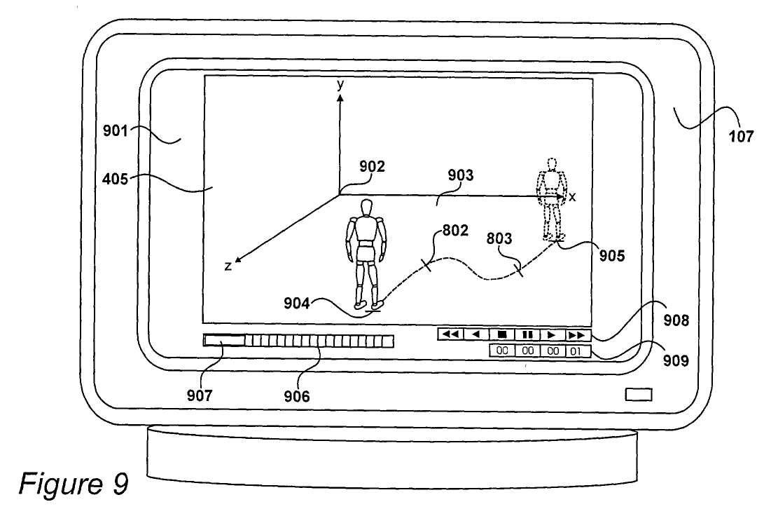

FIG. 9

The target animation sequence 405 generated according to steps 305 to 307 is preferably output to the video display unit 107 of the animation computer system 101 for real-time interaction therewith within a graphical user interface (GUI), which is shown in FIG. 9.

The GUI 901 of animation instructions 402 is preferably divided into a plurality of functional areas, most of which are user-operable. A first area displays target animation sequence 405 as a three-dimensional animation space 902 configured with a reference floor space 903. The bipedal node hierarchy 406 is displayed therein as a humanoid model 601 and an animation path 904, 905 is also shown projected onto floor space 903, along which said model 601 will be animated with the motions described in FIG. 8. For the purpose of clarity, reference markers are shown on said animation path respectively identifying the position in space and thus time at which blending operations 802, 803 should take place. It should be noted however that such reference markers are not required to be displayed within GUI 901 as, according to the present invention, motion clip input 306 may be provided at any point along said animation path, whereby the motion clip so triggered would be immediately blended with the current motion clip.

A second area 906 comprises a conventional user operable time-line configured as a slide bar. The purpose of time-line 906 is to represent the total length in time or number of frames of target animation sequence 405 at any one time as it is generated and written according to steps 305 to 307 and features a user operable slider 907. A user may freely interact with said slider 907, in effect moving said slider to any point between both extremities of time-line 906, whereby animation instructions 402 update the representation of target animation sequence 405 and output the frame equivalent to the position of slider 907 to GUI 901.

A third area 908 comprises conventional user operable animation sequence navigation widgets allowing a user to respectively rewind, reverse play, pause, stop, play or fast forward the sequential order of image frames within the target animation sequence 405. A counter area 909 is provided in close proximity to the clip navigation widgets 908, which is divided into hours, minutes, seconds and frames. The functionality provided by conventional navigation widgets 908 in conjunction with the counter area 909 is comparable to the time-line 906 configured with a slider 907, but allows a user a much more precise control over the navigation as previously described.

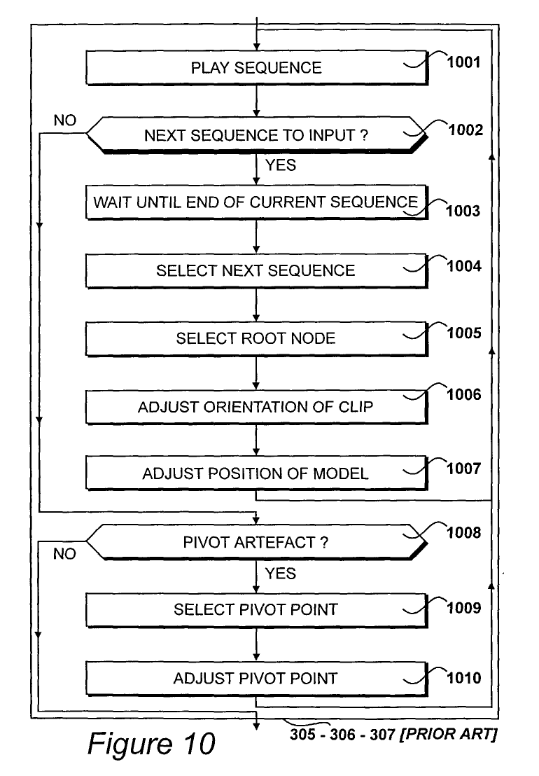

FIG. 10

Upon completing the input configuration of step 304, whereby the GUI 901 outputs the image data in the form of target animation sequence 405 as described in FIG. 9, the animation sequence may now be performed and the parameterising data thereof written to hard disk drive 204 or any removable storage medium 104 or 106 according to steps 305 to 307, which are further described according to the known prior art in FIG. 10 in order to outline the current approach taken to solve the blending problem which the present invention solves.

According to the known prior art, a first portion of the target animation sequence 405 is generated at step 1001 upon animating the human model 601 with a first motion clip, for instance a walking motion clip 411. In accordance with the animation sequence script, said first portion within which the model walks should be followed by a second portion within which said character runs and, preferably, the end of said walking motion should be blended into the beginning of said running motion. Consequently a question is asked at step 1002 as to whether motion clip input has been received to select said second running motion clip. According to the known prior art, said motion clip input may be inputted in real-time during the processing of said first portion.

If the question of step 1002 is answered positively, then animation instructions according to the known prior art first process the entire first portion consisting of the first walk motion clip 411 at step 1003 before selecting said next run motion clip 412 at step 1004. At step 1005, the user selects the root node of the limb which requires adjustment within the target animation sequence along the animation path, generally the hip node 605 such that the orientation within the animation space of the second run motion clip can be adjusted at step 1006 as well as the position of the bio-mechanical model 602 at step 1007. Control is subsequently returned to step 1001, whereby animation instructions according the known prior art either generates a new iteration of the target animation sequence by means of processing the first walk motion clip and then the second run motion clip, including generating in-between frames including the user-implemented blending according to steps 1005 to 1007, or simply generate said second portion including said in-between frames and second run motion clip 412.

Alternatively, if the question of step 1002 is answered negatively, for instance after the second iteration of the target sequence animation including said in-between frames, a second question is asked at step 1008 as to whether there exists discernible artefacts within the target animation sequence as generated, for instance the feet of the character 601 do not realistically interact with the floor space 903 in the second portion because the reference floor level in the second run motion clip is not strictly in line with the equivalent floor level of the first walk motion clip as a result of the orientation and position adjustments of steps 1006 and 1007 respectively. If the question of step 1008 is answered positively, the user preferably selects the bio-mechanical models node closest to said floor level, e.g. floor space 903, which is traditionally known to those skilled in the art as a pivot point, at step 1009 such that the position of said pivot point in terms of height relative to said floor space 903 may be manually adjusted at step 1010 in each in-between frame to correct the artefact identified at step 1008. Control is subsequently returned to step 1001, whereby animation instructions according to the known prior art will again either generate a new target animation sequence incorporating the first walk motion clip, the second run motion clip and further generate in-between frames including the pivot point adjustment according to steps 1009 and 1010, or simply generate the in-between frames and second run motion incorporating said adjustment.

The question asked at step 1008 is eventually answered positively, traditionally after two interactions as outlined above, arising from questions 1002 and 1008 being answered positively for every motion clip to be incorporated back-to-back within a complete target animation sequence.

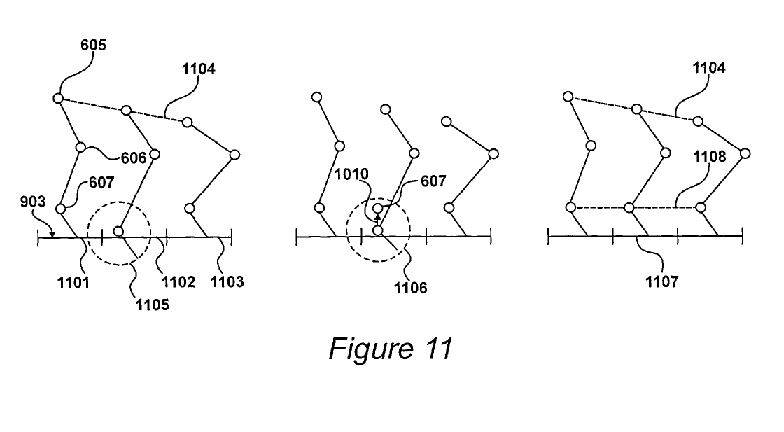

FIG. 11

A representation of an artefact derived from an incorrect pivot point position between two motion clips to be blended is shown in FIG. 11 and interactions therewith according to steps 10-09 and 1010.

A lower limb of a humanoid bio-mechanical model 406 is shown and comprises a “hips” root node 605, a “knee” child node 606 and an “ankle” child node 607, hereinafter referred to as the pivot point 607, positioned relative to the notional floor space 903 of animation space 902 of target animation sequence 405. The leg is shown in relation to said floor space over the course of three consecutive frames 1101, 1102 and 1103, wherein frame 1101 represents the last frame in a walk motion clip 411, frame 1102 represents an in-between frame generated between said frame 1101 and frame 1103, which is the first frame of a run motion clip 412.

For the purpose of clarity, the question of three-dimensional orientation of the model between frames 1101 and 1103 is not shown in this Figure but dotted line 1104 represents the adjustment of the position of the bio-mechanical model carried out according to step 1007 between said frames. According to the known prior art, the three-dimensional position and characteristics of nodes 605 to 607 are interpolated to generate the in-between frame 1102, wherein said interpolation may be a linear or cubic polynomial, such as parametric curves.

Regardless of the type of interpolation used, said interpolation irremediably generates artefacts such as the “foot through floor space” artefact shown at 1105. This problem arises from the fact that according to the known prior art, the aforementioned interpolation is root node-led and thus although the pivot point is also interpolated as a child node of said root node, said interpolation is carried out independently of said floor space 903, such that the pivot point is projected to a biologically/mechanically impossible position, which requires correction.

Said user-implemented correction is shown at 1106, whereby the position of pivot point 607 in relation to floor space 903 is manually adjusted according to step 1010, such that an acceptable in-between frame 1107 is eventually generated in accordance with the processing steps described in FIG. 10, i.e. wherein the position of the pivot point 607 remains biologically/mechanically correct.

With regard to the number of in-between frames to generate for blending motions, which can reach in excess of twenty for each such blending, it can therefore be appreciated that motion clip blending in a target animation sequence according to the prior art is a time consuming and therefore expensive process requiring numerous manual adjustment from a skilled animator and the generating of a complete target animation sequence incorporating dozens or even possibly hundreds of motion clips process to animate dozens or, again, possibly hundreds of model hierarchies cannot be done in real-time according to the known prior art.

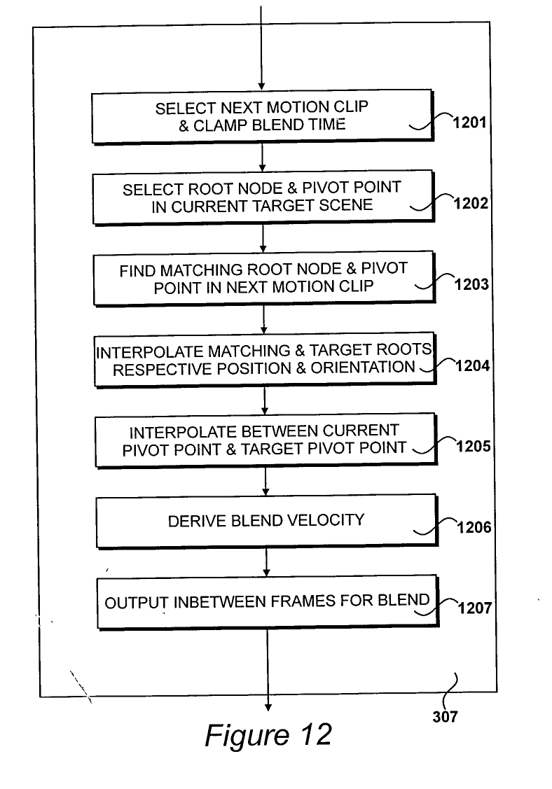

FIG. 12

The present invention, however, provides a method of generating such a complex target animation sequence comprising a plurality of motion clips, including the blending thereof, in real-time. This advantage is provided by the blending operation of step 307, which is further described in FIG. 12.

According to the present invention, animation instructions 402 initially select the root node 605 and the pivot point 607 in the target animation sequence 405 at step 1201, upon receiving clip selection input according to step 306. In the example, motion clip input selection data configured according to step 304 is received in real-time according to step 306 whilst animation instructions 402 are still processing the first walk motion clip 411 and animating the model hierarchy 406. Animation instructions 402 process said selection input data to identify the next motion clip so triggered which, in the example, is run motion clip 412, at step 1202, and said instructions also clamp the maximum blending time as the remaining number of frames in motion clip 411 to be processed. At step 1203, animation instructions 402 find the matching root node and pivot point among the node references 701 in said next motion clip 412.

At step 1204, animation instructions 402 interpolate between the respective position and orientation derived from positional data 702 to 704 of the matching root node identified at step 1203 and those of the current root node selected at step 1201 in the frame generated when motion clips selection input is received according to step 306. At step 1205, animation instructions 402 similarly interpolate between the respective position and orientation derived from positional data 702 to 704 in motion clip 412 of the matching pivot point identified according to step 1203 and those of the current pivot point selected at 1201. The interpolations respectively processed at step 1204 and 1205 are preferably linear interpolations, but it will be easily understood by those skilled in the art that many other types of interpolations can be envisaged to achieve the benefits of the present invention as disclosed, such as cubic curves interpolation.

Upon completing step 1205, the keyframes 1101, 1107 and 1103 can be generated by computer animation system 101 according to the present invention. However, according to the preferred embodiment of the present invention, animation instructions 402 further derive the velocity of the blending operation as the speed profile of the interpolations in order to determine the most appropriate number of in-between frames to generate so as to obtain as seamless a motion transition between the two motion clips to blend as possible.

Thus, upon completing the above step 1206, the keyframes are identified, the interpolations are parameterised and the optimum number of in-between frames derived, whereby animation instructions 402 can output said in-between frames blending said walk motion clip 411 into run motion clip 412 in real-time with outputting blended in-between frames at step 1207.

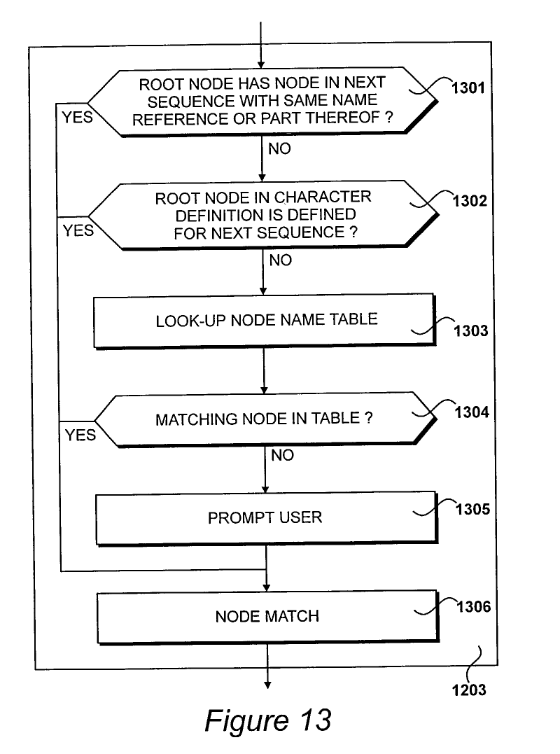

FIG. 13

The processing step 1203 of matching the current root node 605 and pivot point 607 in the target animation sequence with corresponding root node and pivot point references in the next selected motion clip is detailed further in FIG. 13.

Upon selecting the root node 605 and the pivot point 607 in the target animation sequence 405 at step 1202, animation instructions 402 first solve a first question asked at step 1301, as to whether the reference 701 of the current root node 605 in the current motion clip has an equivalent reference in the next motion clip. In the example, the question would therefore ask whether the node reference 701 within the walk motion 411 that is associated to hips root node 605 also exists within the run motion clip 412.

In the preferred embodiment of the present invention, the comparison carried out to answer the first question asked at step 1301 is based upon an elaborate name-matching algorithm, possibly making use of heuristics, whereby a match would be found even in the case of-partially similar node references 701 in the first motion clip 411 and the next motion clip 412 respectively. If the question asked at step 1301 is answered negatively, a second question is asked at step 1302 as to whether the root node 605 is defined within target animation sequence 405 for the next portion of the animation sequence as a node reference 603 of character 406, i.e. whether the condition of matching the bio-mechanical model's root node directly to the next corresponding node reference 701 in the next motion clip is valid or not, as opposed to matching respective node references 701 between both clips according to step 1301.

If the question asked at step 1302 is answered negatively, then at step 1303 animation instructions 402 look at the node name table 604 within character definition 406 as a last resort, for instance because no match can be established between the current clip and/or the character being animated with the selected motion clip. Consequently, a third question is asked at step 1304 as to whether the name table processing according to step 1303 has established a match. If said third question of step 1304 is answered negatively, which would in all likelihood signify that the proposed next motion clip is incompatible with the bio-mechanical model being animated, then animation instructions 402 return an error and subsequently prompt the animator 113 either for a manual node matching input or for a valid selection.

According to the invention, however, processing steps 1303 to 1305 may only be used in the case of an incorrect input configuration at step 304, for instance by selecting a run motion clip within library 404 suitable for animating quadruped bio-mechanical model 407 as opposed to humanoid bipedal model 406. In the respective alternatives of question 1301 being answered positively, or question 1302 being also answered positively or, finally, question 1304 being similarly answered positively, control proceed to step 1306, whereby a node match is achieved.

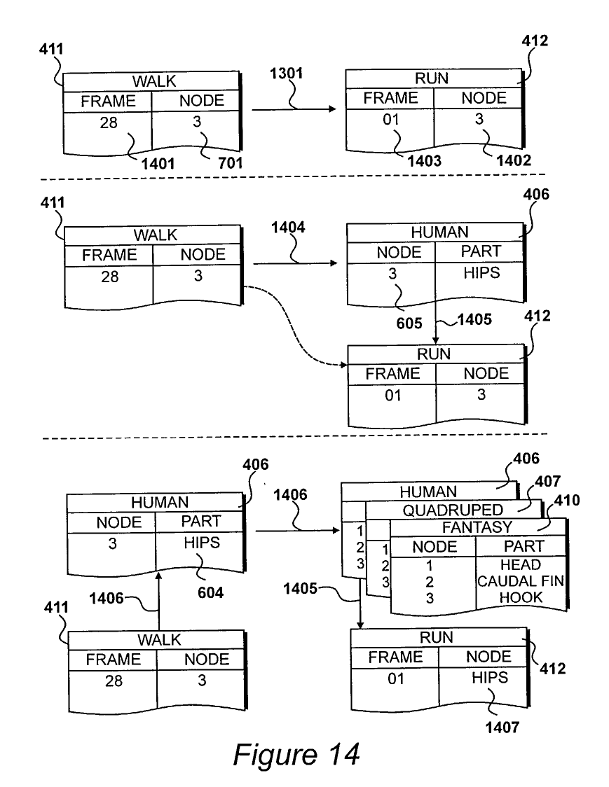

FIG. 14

Respective graphic representations of the matching operations performed according to steps 1301, 1302 and 1304 are shown in FIG. 14.

A first representation of a portion of the data in walk motion clip 411 is provided, wherein the reference 701 of root node 605 in the frame 1401 of the clip currently processed is matched to the corresponding reference 1402 in the first frame 1403 of the next selected motion clip 412 according to the matching operation performed at step 1301.

A second representation of the reference 701 of the root node 605 selected at frame 1401 is shown as being first cross-referenced with root node 605 within node hierarchy 406 at 1404, whereby reference 701 is subsequently matched to reference 1402 of run motion clip 412 at frame 1403 according to the matching operation of step 1302, because root node 605 is defined for animation by said run motion clip 412 at 1405. The matching operation of said second representation performed according to step 1302 may for instance be necessary where a particular embodiment of the present invention does not include instructions for effecting the elaborate name match described herein above in relation to step 1301.

A third representation of reference 701 selected at frame 1401 in walk motion clip 411 is shown in the context of the matching operation requiring to look up the node name table 604. Animation instructions 402 thus initially cross-reference said reference 701 with the character definition 406 at 1406 in order to determine the node name 604, whereby said looking up operation is for instance required because the walk motion clip 412 was acquired from an external motion clip library 404 within which references 701 are configured with a completely different data set as shown at 1407. The corresponding node name 604 subsequently enables the matching of reference 701 with reference 1407 according to the same principles described at 1405 and 1302 above.

For the purpose of clarity, the matching operation performed according to step 1203 is herein based upon the matching of reference 701 to reference 1402 according to step 1301.

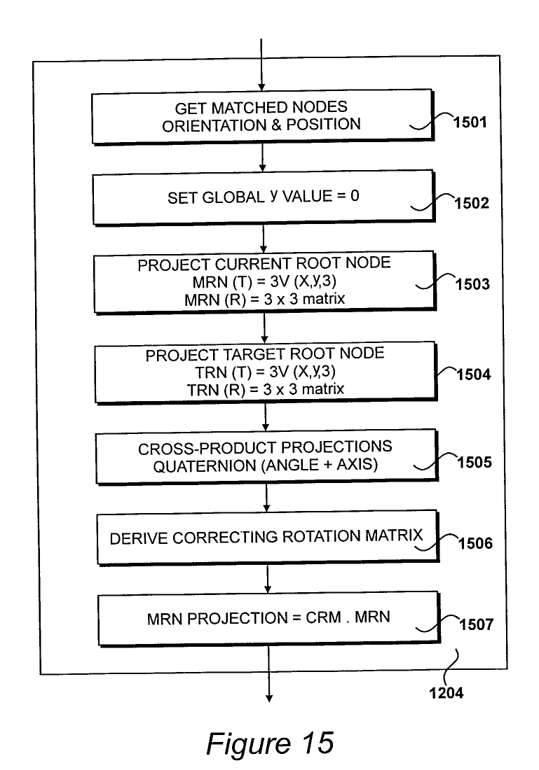

FIG. 15

The interpolation between the respective position and orientation of the current root node and the corresponding target root at step 1204 is further detailed in FIG. 15.

At step 1501, animation instructions 402 obtain three-dimensional data respectively defining the orientation and position of the current root node 605 and the corresponding root node 1402 matched at step 1203, hereinafter referred to as the target root node, within animation space 902. At step 1502, the data parameter respectively defining the orientation and position of said nodes relative to the vertical axis of the animation space 902 is zeroed such that the three-dimensional vector defining the orientation and position of the current root node 605 may be projected on to the floor space 903 at step 1503 and, similarly, the corresponding three-dimensional vector defining the orientation and position of the target root node 1402 may also be projected on to floor space 903 at step 1504. In both steps 1503 and 1504, said vector projections are implemented by means of conventional translation and rotation transformation matrices, which will be well known to those skilled in the art.

At step 1505, the cross product of the projections respectively obtained at steps 1503 and 1504 provides a transformation angle and axis, also known to those skilled in the art as the quaternion from the current position to the target position, from which a correcting rotation matrix (CRM) can be derived at step 1506 and with which to process the three-dimensional positional data of the current root node at step 1507 to achieve the correct projection thereof within animation space 902 in relation to floor space 903.

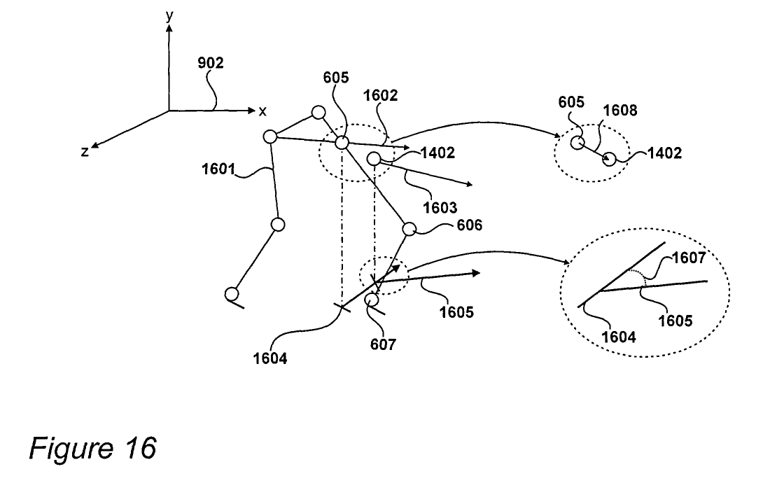

FIG. 16

The interpolation between the positional and directional data of root node 605 and the positional and directional data of target root node 1402 of step 1204 as further described in FIG. 15 is shown within animation space 902 in FIG. 16.

A portion 1601 of node hierarchy 406 is represented as the lower limbs of model 602 connected by the hips. The various nodes 603 of said portion 1601 notably include root node 605, child nodes 606 and pivot point 607 and all of said nodes 603 are positioned and oriented according to data 702 to 704 of their corresponding node references 701 at frame 1401.

A vector 1602 is shown originating from root node 605, the direction of which defines the orientation of root node 605 within the three-dimensional animation space 902 and the length of which defines the velocity of said node within said space in relation to the dynamic of the walk motion.

A vector 1603 is shown originating from target node 1402, the direction of which defines the orientation of said target node 1402 within animation space 902 and the length of which defines the velocity thereof within said space in relation to the dynamic of the run motion, therefore vector 1603 is longer than vector 1602 as a run motion is faster than a walk motion.

As the vertical (Y) positional data is zeroed according to step 1502, the current root node 605 is projected on to floor space 903 according to step 1503, thus the orientation and position of vector 1602 is similarly projected on to said floor space 903 at 1604. The target root node 1402 and corresponding three-dimensional vector 1603 are similarly projected on to said floor space 903 at 1605 according to processing step 1504.

The angle 1607 and the axis 1608 are therefore obtained according to the cross product of processing step 1505, whereby current root node 605 may now be projected to target root node 1402 accurately along said axis 1608, also known to those skilled in the art as a space curve.

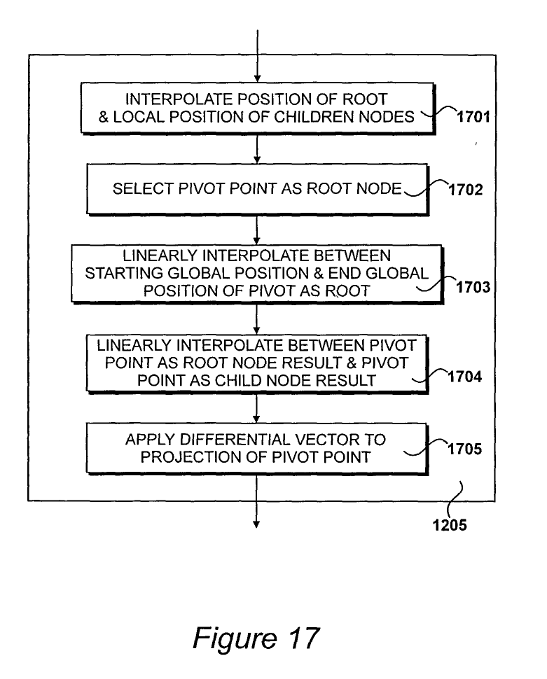

FIG. 17

The interpolation between the current pivot point and the target pivot point according to the following processing step 1205 according to the present invention is further detailed in FIG. 17.

At step 1701 animation instructions 402 interpolate between the respective positions of current root node 605 and its children nodes 606, 607 and the respective positions of target root node 1402 and its children node, respectively corresponding to said children node 606, 607. At step 1702, the pivot point 607 is selected by animation instructions 402 as a root node, whereby a first linear interpolation is processed between the starting position of pivot point 607 in frame 1401 and the end position of said pivot point 607 in frame 1403 at step 1703.

Animation instructions 402 subsequently process a second linear interpolation at step 1704 between the result of the first interpolation of pivot point 607 as a child node at step 1701 and the result of the interpolation of said pivot point 607 as a root node at step 1703.

A differential vector is thus obtained from the last linear interpolation of step 1704 which shall be applied to the projection of pivot point 607 of model hierarchy 406, whereby with reference to FIGS. 10 and 11, accurate frame 1107 is obtained in real-time as a result of said application without encountering any of the artefact problems solved according to processing steps 1008 to 1010 according to the known prior art.

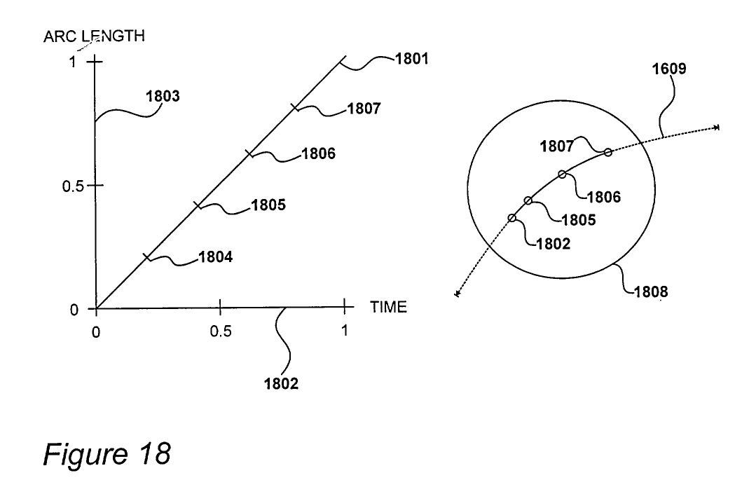

FIG. 18

Keyframes for the blending operation according to the invention are identified in the current description as the frame being rendered as motion clip selection input is received according to processing step 306, e.g. frame 1401, and the first frame 1403 of the next selected motion clip. The in-between frames to be output in order to equip the character within the target animation sequence with a seamless transition between the first walk motion clip 411 and the second run motion clip 412 may be accurately rendered according to processing steps 1201 to 1205 as previously described. However, the velocity of the interpolation must be derived according to step 1206 in order to accurately determine how far the various nodes within node hierarchy 406 travel along the interpolation curve given a parameter value, wherein said parameter value relates to the respective dynamism of the motion clips to be blended.

In the simplest embodiment of the present invention, interpolation velocity may be constant between keyframes 1401 and 1403, whereby for each time increment the respective positions of the nodes are updated at a constant rate and said constant is for instance the display frame-rate of the target format of the target animation sequence 405. Utilising the display frame-rate as said constant parameter is equivalent to using time, for instance one twenty-forth of a second if the target format is a cinematographic movie. Time would thus be incremented in constant amount and updated node positions provided along space curve 1608 to render an in-between frame every twenty-fourth of a second.

In an alternative embodiment of the present invention, however, cubic curves are used to interpolate the position and orientations of the node hierarchy as previously described, preferably as parametric curves, for instance cubic polynomial Hermite curves.

In the alternative embodiment of the present invention, cubic curve interpolation is used to achieve a more accurate projection of the current root nodes 605 to the target root node 1402, and similarly for the projection of the current pivot point 607 to the target pivot point. However, a problem arises out of the constant velocity approach outlined above with cubic curve interpolation, because uniform steps in a parameter defining constant velocity do not necessarily correspond to uniform path distances. This problem is further described in FIG. 18.

In the first preferred embodiment of the present invention, linear interpolation is preferred as a means of reducing the processing overhead to accomplish the blending operation at 307. It is therefore relatively easy to determine a speed curve 1801, which maps the time/frame parameter 1802 to arc length 1803 and thus represents a constant velocity interpolation from keyframe 1401 to keyframe 1403. Speed curve 1801 thus provides a simple means of determining the distance 1803 travelled along the space curve 1608 according to uniform steps or increments in the time parameter 1802 at constant velocity.

However, uniform increments 1804 to 1807 in the time parameter 1802 do not necessarily correspond to uniform path distances when related to space curve 1609, as shown at 1808, in the case of cubic curve interpolation. An alternative relationship is required between the time parameter 1802 and the distance travelled 1803 in order to obtain the correct interpolated position of every given in-between frame.

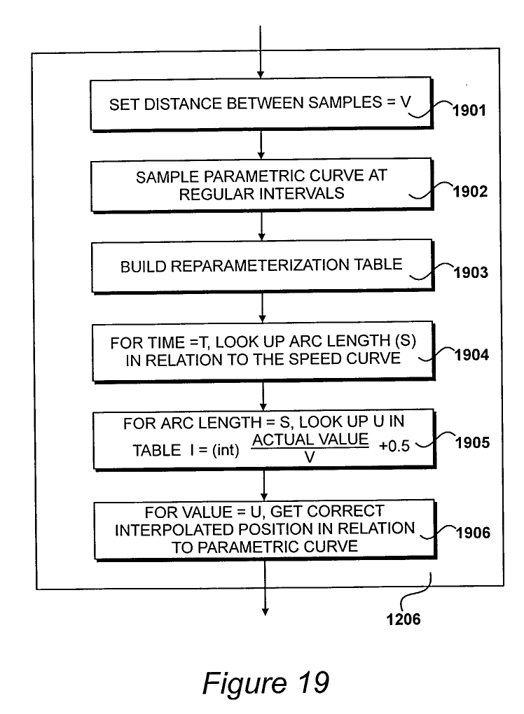

FIG. 19

The blending time or interpolation velocity processed by animation instructions 402 at processing step 1206, which solve the problem described in FIG. 18, is further described in FIG. 19.

The relationship between the time/frame parameter 1802 and the distance 1803 travelled along the animation path is generated by animation instructions 402 by reparameterising the space curve 1608 by the arc length 1803. At step 1901, animation instructions 402 therefore set a distance between samples (V) corresponding to uniform increments 1804 to 1807 in the time parameter 1802, such that the space curve 1608 may be sampled at regular intervals at step 1902.

Animation instructions subsequently build a temporary reparameterisation table at step 1903, which may also be referred to as a table of arc length, referencing the arc length value 1803 at the space curve value 1608 corresponding to each subsequent sample 1804 to 1807. Upon completing the table building processing step 1903, animation instructions 402 look up the arc length (S) value 1803 in relation to the speed curve 1801 for each frame/time parameter value 1802 at step 1904. Upon obtaining the arc length (S) value 1803 at step 1904, animation instructions 402 subsequently look at the corresponding parametric value (U) in the reparameterisation table of processing step 1903. Upon obtaining the parametric value (U) at step 1905, animation instructions 402 eventually obtain the correct interpolated position of the node along the space curve in the in-between frame by evaluating said space curve 1608 at said resulting parametric value (U) at step 1906.

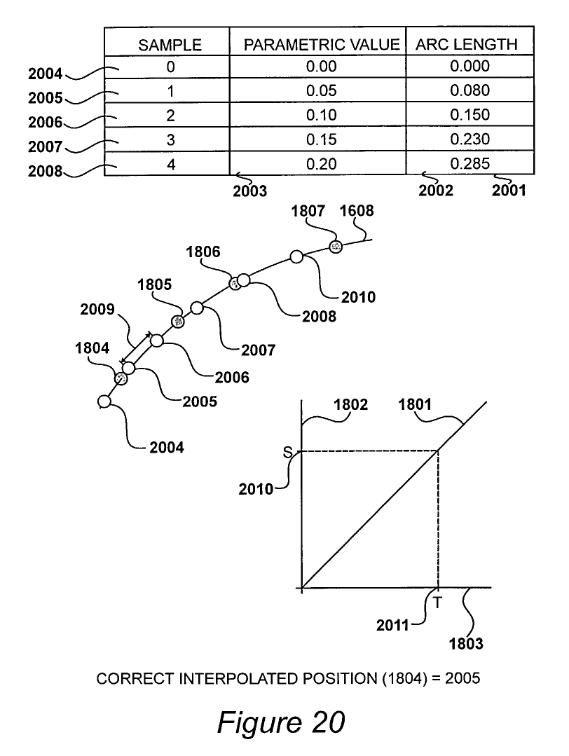

FIG. 20

A relationship between the time parameter 1802 and the distance travelled 1803 to overcome the problem shown in FIG. 18 according to the processing steps described in FIG. 19 is shown in FIG. 20.

A reparameterisation table 2001 is shown within which arc length values (S) 2002 are cross-referenced with corresponding space curve values (U) 2003 for each sample 2004 to 2008. Said samples 2004 to 2008 are taken from space curve 1608 according to processing step 1902 at a uniform distance (V) 2009 according to step 1901.

In order to accurately generate the first in-between frame required by the blending 307 of walk motion clip 411 with run motion clip 412, animation instructions 402 look up the arc length (S) 2010 at the corresponding time parameter (T) 2011 in relation to speed curve 1801, according to processing step 1904. Animation instructions 402 can subsequently look up the corresponding parametric value (U) 2003 which, in the example, is sample 2005. Animation instruction 402 can finally obtain the correct interpolated position 2005 for the given in-between frame corresponding to time parameter 2011 according to processing step 1906, as opposed to generate a first in-between frame with an incorrect node position 1804 along the space curve 1608.

Processing steps 1904 to 1906 are iteratively carried out until the entire space curve 1608 is processed, whereby all of the in-between frames required to seamlessly blend first walk motion clip 411 into next run motion clip 412 have been generated and output, and animation instructions 402 are now processing the data of run motion clip 412 to animate node hierarchy 406 therewith, having thus accurately blended two consecutive motion clips in real-time.

What is claimed is:

1. Apparatus for generating animation data, including storage means comprising at least one character defined as a hierarchy of parent and children nodes and animation data defined as the position in three-dimensions of said nodes over a period of time, memory means comprising animation instructions, wherein said processing means are configured by said animation instructions to perform the steps of
animating said character with first animation data; selecting nodes within said first animation data when receiving user input specifying second animation data in real-time;
matching said nodes with corresponding nodes within said second animation data;
interpolating between said nodes and said matching nodes; and
animating said character with second animation data, having blended a portion of said first animation data with said second animation data in real-time.

2. Apparatus according to claim 1, wherein said processing means are further configured by said animation instructions to perform the step of configuring input data to be generated in real time by user-operable input devices.

3. Apparatus according to claim 1, wherein said storage means comprises a plurality of characters, whereby said processing means animate a plurality of characters with first and second animation data.

4. Apparatus according to claim 1, wherein said nodes include at least one root node and one pivot point.

5. Apparatus according to claim 1, wherein said matching step includes comparing node names or node references or portions thereof.

6. Apparatus according to claim 1, wherein said interpolation is linear.

7. Apparatus according to claim 1, wherein said interpolation is cubic.

8. Apparatus according to claim 6 or 7, wherein the velocity of said interpolation is a function of the velocity of said nodes in said first animation data.

9. Apparatus according to claim 8, wherein said velocity is constant.

10. Apparatus according to claim 1, wherein said animation is keyframe-based, forward kinematics-based or inverse kinematics-based.

11. A method of generating animation data, including at least one character defined as a hierarchy of parent and children nodes and animation data defined as the position in three-dimensions of said nodes over a period of time, wherein said method comprises the steps of
animating said character with first animation data; selecting nodes within said first animation data when receiving user input specifying second animation data in real-time;
matching said nodes with corresponding nodes within said second animation data;
interpolating between said nodes and said matching nodes; and
animating said character with second animation data having blended a portion of said first animation data with said second animation data in real-time.

12. A method according to claim 11, further comprising the step of configuring input data to be generated in real time by user-operable input devices.

13. A method according to claim 11, further including a plurality of characters, whereby said method further comprises the step of animating a plurality of characters with first and second animation data.

14. A method according to claim 11, wherein said nodes include at least one root node and one pivot point.

15. A method according to claim 11, wherein said matching step includes comparing node names or node references or portions thereof.

16. A method according to any of claim 11, wherein said interpolation is linear.

17. A method according to any of claim 11, wherein said interpolation is cubic.

18. A method according to claims 16 or 17, wherein the velocity of said interpolation is a function of the velocity of said nodes in said first animation data.

19. A method according to claim 18, wherein said velocity is constant.

20. A method according to claim 11, wherein said animation is keyframe-based, forward kinematics-based or inverse kinematics-based.

21. A computer-readable medium having computer readable instructions executable by a computer, such that said computer performs the steps of:
animating a character defined as a hierarchy of parent and children nodes with first animation data defined as the position in three-dimensions of said nodes over a period of time;
selecting nodes within said first animation data when receiving user input specifying second animation data in real-time;
matching said nodes with corresponding nodes within said second animation data;
interpolating between said nodes and said matching nodes; and
animating said character with second animation data having blended a portion of said first animation data with said second animation data in real-time.

22. A computer-readable medium according to claim 21, further comprising the step of configuring input data to be generated in real time by user-operable input devices.

23. A computer-readable medium according to claim 21, further including a plurality of characters, whereby said computer further performs the step of animating a plurality of characters with first and second animation data.

24. A computer-readable medium according to claim 21, wherein said nodes include at least one root node and one pivot point.

25. A computer-readable medium according to claim 21, wherein said matching step includes comparing node names or node references or portions thereof.

26. A computer-readable medium according to claim 21, wherein said animation is keyframe-based, forward kinematics-based or inverse kinematics-based.

27. A computer system programmed to process image data, including storage means configured to store at least one character defined as a hierarchy of parent and children nodes and animation data defined as the position in three-dimensions of said nodes over a period of time, memory means configured to store animation instructions and processing means configured by said animation instructions to perform the steps of;
animating said character with first animation data; selecting nodes within said first animation data when receiving user input specifying second animation data in real-time;
matching said nodes with corresponding nodes within said second animation data;
interpolating between said nodes and said matching nodes; and
animating said character with second animation data, having blended a portion of said first animation data with said second animation data in real-time.

28. A computer system programmed according to claim 27, further comprising the step of configuring input data to be generated in real time by user-operable input devices.

29. A computer system programmed according to claims 27 and 28, further including a plurality of characters, whereby said method further comprises the step of animating a plurality of characters with first animation data.

30. A computer system programmed according to any of claims 27 to 29, wherein said nodes include at least one root node and one pivot point.

31. A computer system programmed according to any of claims 27 to 30, wherein said matching step includes comparing node names or node references or portions thereof.

32. A computer system programmed according to claim 27, wherein said animation is keyframe-based, forward kinematics-based or inverse kinematics-based.
